(19) United States
(12) Patent Application Publication
(10) Pub. No.: US 2013/0249699 A1
(43) Pub. Date: Sep. 26, 2013

(54) ALARM METHOD AND APPARATUS FOR TERMINAL ANTI-EAVESDROPPING

(71) Applicant: HUAWEI TECHNOLOGIES CO., LTD., Shenzhen (CN)

(72) Inventor: Dongsheng Liu, Shanghai (CN)

(73) Assignee: Huawei Technologies Co., Ltd., Shenzhen (CN)

(21) Appl. No.: 13/743,984

(22) Filed: Jan. 17, 2013

(30) Foreign Application Priority Data
Feb. 29, 2012 (CN) 201210049962.7

(51) Int. Cl. H04M 1/19

(52) U.S. Cl. CPC H04M 1/19
USPC 340/654

(57) ABSTRACT

The prevent invention provides an alarm method and apparatus for terminal anti-eavesdropping. The method includes: acquiring the working state of a microphone of a terminal; and sending alarm information according to the working state of the microphone of the terminal. Particularly, alarm information can be sent when the microphone of the terminal is switched on. According to the embodiments of the present invention, a user can be alerted when the background sound of the terminal may be eavesdropped on, thereby improving the security of communications. In addition, an embodiment of the present invention further provides a terminal having an anti-eavesdropping alarm function.

### CROSS-REFERENCE TO RELATED APPLICATIONS

This application claims priority to Chinese Patent Application No. 201210049962.7, filed on Feb. 29, 2012, which is hereby incorporated by reference in its entirety.

### FIELD OF THE INVENTION

The present invention relates to the field of communications technologies, and in particular to an alarm method and apparatus for terminal anti-eavesdropping.

### BACKGROUND OF THE INVENTION

As intelligent terminals are becoming increasingly powerful, they are increasingly engaged in our daily life. Users can download and install programs such as software and games offered by third-party vendors from the Internet so as to extend functions of such terminals through the programs. This brings convenience to users. However, it also provides an opportunity for malicious users to illegally embed an eavesdropping program into an intercepted terminal, and then intercept calls and short messages of the user of the intercepted terminal and the background sound of the environment where the user is located without being noticed by the user through the eavesdropping software. In this way, the privacy of the user of the intercepted terminal is obtained, thereby seriously damaging the personal interest of the terminal user.

The eavesdropping software uses an ordinary call function of the terminal, and automatically answers the call through a backdoor program in place of the user. In addition, after the eavesdropping software is installed, it is difficult to find the installation track from the terminal interface. Therefore, it is difficult for a common user to identify the eavesdropping software. Currently, a common manner for anti-eavesdropping is as follows: On one hand, the terminal operation habits of the users are restricted so as to avoid downloading and installation of Trojan software; on the other hand, an anti-virus software is installed to prevent and expel viruses and Trojan programs.

The anti-virus software compares the codes of an application software with virus feature codes recorded in the virus database to judge whether the software downloaded by a user is virus software, identify the name of the software virus, and then remove the virus according to the result of virus detection. Therefore, the user is required to update the virus database in real time. If the virus database has expired or has not recorded latest eavesdropping viruses, the user terminal may be eavesdropped on.

### SUMMARY OF THE INVENTION

Embodiments of the present provide an alarm method and apparatus for terminal anti-eavesdropping so as to alert the user when background sound of the terminal may be eavesdropped on, thereby improving the security of communications.

Therefore, the embodiments of the present invention provide the following technical solutions.

an alarm method for terminal anti-eavesdropping, including:

acquiring the working state of a microphone of a terminal; and

sending alarm information according to the working state of the microphone of the terminal.

an alarm apparatus for terminal anti-eavesdropping, including:

a state acquiring unit, adapted to acquire the working state of a microphone of a terminal; and

an alarm information sending unit, adapted to send alarm information according to the working state of the microphone of the terminal.

A terminal, including the preceding alarm apparatus for anti-eavesdropping where the alarm apparatus for anti-eavesdropping is connected to a microphone of the terminal or an audio codec of the terminal; the alarm apparatus for anti-eavesdropping is adapted to acquire the working state of the microphone of the terminal; and the alarm apparatus for anti-eavesdropping sends alarm information according to the working state of the microphone of the terminal.

According to the alarm method and apparatus for terminal anti-eavesdropping in the embodiments of the present invention, the working state of a microphone of a terminal is acquired, and alarm information is sent to the user according to the working state of the microphone of the terminal to alert the user that the background sound may be eavesdropped on. In this way, the user is alerted when the background sound of the terminal may be eavesdropped on. Particularly, alarm information can be sent when the microphone is switched on. However, if the microphone is switched on, it is possible that the terminal user is using the terminal normally or that the background sound of the user is being illegally intercepted by a malicious user. Therefore, after viewing or hearing the alarm information, the terminal user needs to further check whether the background sound is being eavesdropped on according to the actual using state of the terminal. In addition, an embodiment of the present invention further provides a terminal having the preceding anti-eavesdropping alarm function. The embodiments of the present invention can improve the security of communications.

### BRIEF DESCRIPTION OF THE DRAWINGS

To illustrate the technical solutions in the embodiments of the present invention or in the prior art more clearly, the following briefly describes the accompanying drawings required for describing the embodiments or the prior art. Apparently, the accompanying drawings in the following descriptions merely show some of the embodiments described in the present application, and persons of ordinary skill in the art can obtain other drawings from the accompanying drawings.

FIG. 1 is a flow chart of an implementation manner of an alarm method for terminal anti-eavesdropping according to an embodiment of the present invention;

FIG. 2 is a flow chart of another implementation manner of an alarm method for terminal anti-eavesdropping according to an embodiment of the present invention;

FIG. 3 is a schematic structural diagram of an implementation manner of an alarm apparatus for terminal anti-eavesdropping according to an embodiment of the present invention;

FIG. 4 is a schematic structural diagram of another implementation manner of an alarm apparatus for terminal anti-eavesdropping according to an embodiment the present invention;

FIG. 5 is a schematic structural diagram of an implementation manner of a state acquiring unit according to an embodiment of the present invention;

FIG. 6 is a schematic structural diagram of another implementation manner of a state acquiring unit according to an embodiment of the present invention;

FIG. 7 is a schematic structural diagram of a terminal having an anti-eavesdropping alarm function according to an embodiment of the present invention;

FIG. 8 is a schematic structural diagram of the front of a terminal according to an embodiment of the present invention; and

FIG. 9 is a schematic structural diagram of a side of a terminal according to an embodiment of the present invention.

### DETAILED DESCRIPTION OF THE EMBODIMENTS

To make the solutions of the present invention better understood by persons skilled in the art, the following describes in further detail the embodiments of the present invention with reference to the accompanying drawings and embodiments.

According to the alarm method and apparatus for terminal anti-eavesdropping in the embodiments of the present invention, the working state of a microphone of a terminal is acquired, and alarm information is sent to the user according to the working state of the microphone of the terminal to alert the user that the background sound may be eavesdropped on; and then the user further checks whether eavesdropping is underway according to the actual using state of the terminal. In this way, the user is alerted when the background sound of the terminal may be eavesdropped on.

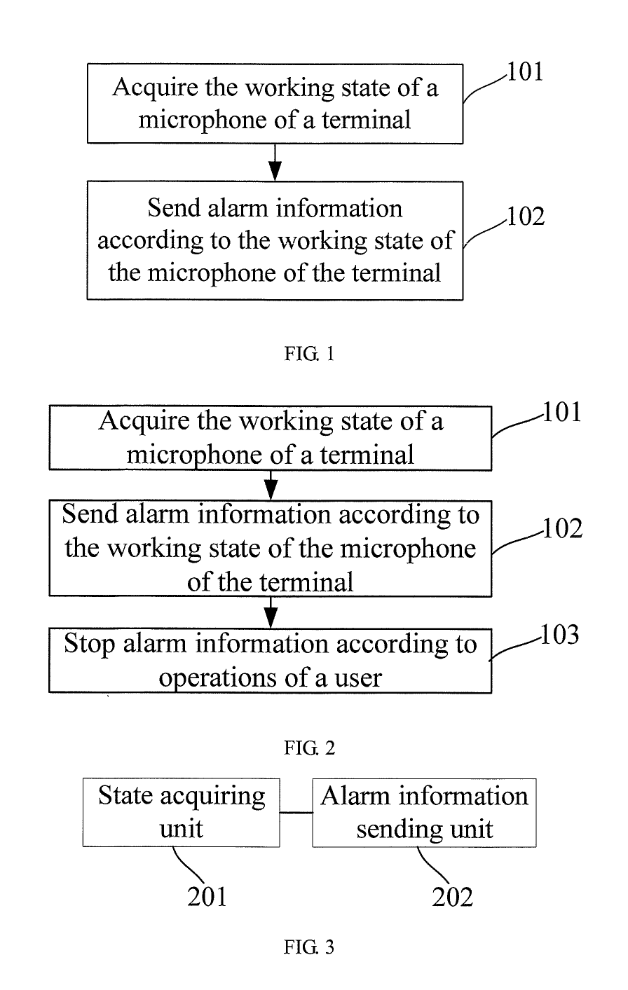

FIG. 1 is a flow chart of an alarm method for terminal anti -eavesdropping according to an embodiment of the present invention. The method includes:

Step 101: Acquire the working state of a microphone of a terminal.

If a malicious user wants to eavesdrop on the background sound of the environment where the intercepted user is located through the terminal so as to acquire the privacy information of the intercepted user, the malicious user at least needs to remotely start the microphone of the terminal of the intercepted user. Therefore, the working state of the microphone of the terminal is an important factor for judging whether the background sound of the terminal is being intercepted. The method for acquiring the working state of a microphone varies according to the type of the microphone, which is not described in detail here.

Step 102: Send alarm information according to the working state of the microphone of the terminal.

Based on different applications, this step can be implemented in the following two manners.

One is that alarm information is sent when the microphone is switched on. That is to say, in normal circumstances, no alarm information is sent; only when the background sound may be intercepted, alarm information is sent to alert the user.

The other is that alarm information is sent when the microphone is switched off. That is to say, in normal circumstances, alarm information is sent; when the background sound may be intercepted, the sending of alarm information is stopped to alert the user.

The preceding two manners differ in the basis for judging whether to send alarm information and the way of alerting the user, but they both ultimately intend to alert the user.

According to the alarm method for terminal anti-eavesdropping in this embodiment, after the alarm information is sent to the user, the user needs to further check whether eavesdropping is underway according to the using state of the terminal. Taking the manner of sending alarm information when the microphone is switched on as an example, the following briefly describes the implementation process of judging whether eavesdropping is underway.

If the working state of the microphone acquired in step 101 shows that the microphone is switched on, indicating that the terminal is processing audio information, alarm information is sent to the terminal user through sound, vibration, flashing, or any combination of them to alert the user that the terminal is working. After hearing or viewing the alarm information, the user judges whether eavesdropping is underway according to the current using state of the terminal. The specific judgment process is as follows:

If the terminal has started a call service and/or recording service, that is, the user is using the terminal for calling and/or recording, it can be judged that the terminal is working normally and its background sound is not being eavesdropped on; and

If the terminal has not started the call service and/or recording service, it can be judged that the terminal is working abnormally and may be eavesdropped on by a malicious user.

In this embodiment, the working state of the microphone of the terminal is acquired in real time, and alarm information is sent to the terminal user when the microphone is powered on. If the microphone is switched on, it is possible that the terminal user is using the terminal normally or that the background sound of the user is being illegally intercepted by a malicious user. Therefore, after the alarm information is sent, the terminal user needs to further check whether the background sound is being intercepted according to the actual working state of the terminal, thereby improving the security of communications.

FIG. 2 is a flow chart of another implementation manner of an alarm method for terminal anti-eavesdropping according to an embodiment of the present invention. The method includes:

Step 103: Stop alarm information according to a operation of a user.

Still take the manner of sending alarm information when the microphone is switched on as an example. Alarm information may be sent either when the user is using the terminal normally or when the background sound of the terminal is being illegally intercepted. However, after hearing or viewing the alarm information in either of the preceding circumstances, the user can manually control the terminal to stop sending alarm information. If the user is using the terminal normally, after the terminal is controlled to stop sending alarm information, the user can use the terminal normally; if the background sound is being illegally intercepted by a malicious user, after the user is alerted to take certain preventive measures, the sending of alarm information can also be stopped according to the operation of the user. Specially, the step of stopping alarm information according to the operation of the user can be implemented in two manners.

One is to control through a software program the terminal to stop sending alarm information; that is, the user chooses to stop alarm information by starting the software program. If this manner is used, a configuration interface of the software program is not open to other application programs, so as to prevent a malicious user from illegally controlling through virus software the stopping of sending of the alarm information.

The other is to stop alarm information according to the switch-off or switch-on of a hardware switch by the user. That is to say, the user can control through the hardware switch the terminal to stop sending alarm information; specifically, the user can choose to stop alarm information by controlling a hardware switch like a push button switch or a slide switch. When this manner is used, illegal control by a malicious user can be effectively prevented, thereby improving the security and reliability of the technical solution in this embodiment of the present invention.

The following briefly describes the implementation manner of acquiring the working state of a microphone of a terminal in step 101.

For an active microphone, because an Audio Codec (audio codec, where Codec is a blend of COder and DECoder, and refers to a coder and decoder) chip supports configuring the power supply of the microphone to the Power on state when the microphone is working and to the Power off state when the microphone is not working. Therefore, the power supply state of the microphone can be used as a basis for judging whether the microphone is working. If the power supply of the microphone is turned on (that is, is configured to the Power on state), it indicates that the microphone is working, and alarm information can be sent to the terminal user; if the power supply of the microphone is shut down (that is, is configured to the Power off state), it indicates that the microphone is not working and cannot be intercepted, so the user does not need to be alerted.

When the microphone is working, the Audio Codec chip must be working. Therefore, for a passive microphone, the working state of the Audio Codec chip can be used as a basis for judging whether the microphone is working. If the Audio Codec chip is working, it indicates that the microphone is working, and alarm information can be sent to the terminal user; if the Audio Codec chip is not working, it indicates that the microphone is not working, and no alarm information needs to be sent to the user.

It should be noted here that for an active microphone, the working state of the Audio Codec chip can also be a basis for judging whether the microphone is working.

If it is judged that the microphone is switched on and alarm information needs to be sent to the user, the user can be alerted in the following manner: switching on/off or flashing the indicator; providing an audible alarm through a warner or a buzzer; or adopting a vibration manner to alert the user. It should be particularly noted that to ensure the security and reliability of this embodiment of the present invention, for any alerting manner that needs to be implemented through a software program (for example, setting a flashing time for an indicator through a software program), the configuration interface of the program is not be open to other application programs. In this way, the illegal control by a malicious user can be effectively avoided, thereby improving the security of communications.

Accordingly, an alarm apparatus for terminal anti-eavesdropping is further provided in an embodiment of the present invention. FIG. 3 is a schematic structural diagram of the apparatus. The apparatus includes:

a state acquiring unit 201, adapted to acquire the working state of a microphone of a terminal; and

an alarm information sending unit 202, adapted to send alarm information according to the working state of the microphone of the terminal.

The terminal according to this embodiment of the present invention acquires the working state of a microphone of a terminal, and sends alarm information information to the user according to the working state of the microphone. Particularly, when the microphone is switched on, alarm information can be sent through audio, vibration, flashing, or any combination of them to alert the user that the background sound may be eavesdropped on; then the user further checks whether eavesdropping is underway according to the actual using state of the terminal. In this way, the user is alerted when the background sound of the terminal may be eavesdropped on. Assuredly, when the microphone is switched off, alarm information can also be sent to the user to alert the user of the possible eavesdropping. In this embodiment of the present invention, the basis for sending alarm information and the manner for alerting the user are not limited, as long as the user can be alerted.

Specifically, the user can check whether the background sound is being eavesdropped on through the following methods:

If the terminal has started a call service and/or recording service, it can be judged that the background sound of the terminal is not being eavesdropped on; and if the terminal has not started the call service and/or recording service, it can be judged that the background sound of the terminal may be eavesdropped on.

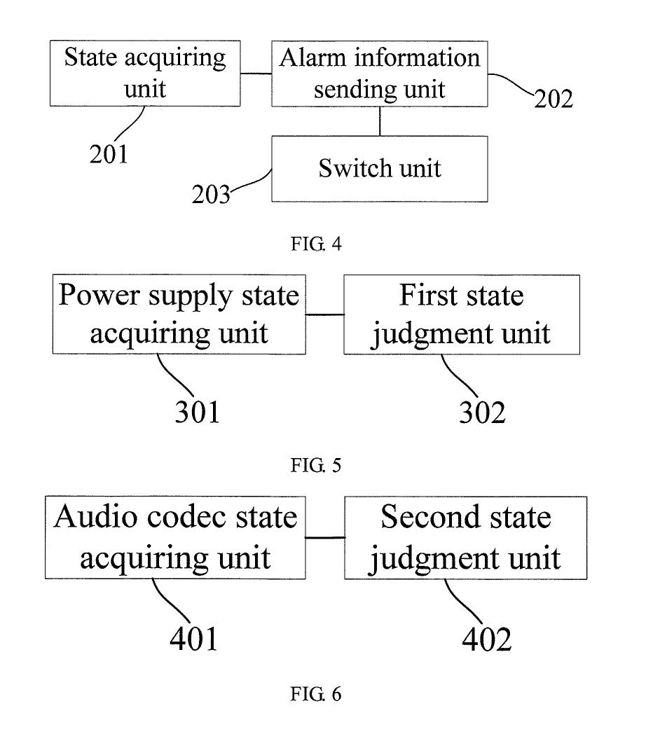

Further, after hearing or viewing the alarm information, the terminal user can manually control the alarm information sending unit to stop continuing sending alarm information. As shown in FIG. 4, the alarm apparatus for terminal anti-eavesdropping further includes:

a switch unit 203, adapted to stop alarm information according to a operation of a user after the alarm information sending unit sends alarm information.

It should be noted here that the functions of the switch unit can be implemented through a software program; however, it is required to ensure that the configuration interface of the software program is not be open to other application programs, so as to prevent a malicious user from illegally controlling through virus software the switch unit to stop sending alarm information. In addition, the functions of the switch unit can also be implemented through a hardware switch. In this way, illegal control by a malicious user can be effectively avoided, thereby improving the security and reliability of the technical solutions in this embodiment of the present invention.

Further, as the type of the microphone of a terminal varies, the composition of the state acquiring unit for acquiring the working state of a microphone varies slightly. FIG. 5 is a schematic structural diagram of an implementation manner of the state acquiring unit. This implementation manner applies to an active microphone. Specifically, the state acquiring unit includes:

a power supply state acquiring unit 301, adapted to acquire the power supply state of a microphone of a terminal; and a first state judgment unit 302, adapted to: when the microphone of the terminal is powered on, determine that the microphone of the terminal is switched on.

FIG. 6 is a schematic structural diagram of another implementation manner of the state acquiring unit. This implementation manner applies to both active and passive microphones. Specifically, the state acquiring unit includes:

an audio codec state acquiring unit 401, adapted to acquire the working state of an audio codec of a terminal; and

a second state judgment unit 402, adapted to: when the audio codec is switched on, determine that the microphone of the terminal is switched on.

Accordingly, an embodiment of the present invention further provides a terminal having an anti-eavesdropping alarm function. The terminal includes the preceding alarm apparatus for anti-eavesdropping. The alarm apparatus for anti-eavesdropping is connected to a microphone of the terminal or an audio codec of the terminal. The anti-eavesdropping alarm function is adapted to acquire the working state of the microphone of the terminal, and send alarm information according to the working state of the microphone of the terminal.

It should be noted that when the microphone is switched on, the alarm apparatus for anti-eavesdropping inside the terminal can send alarm information, that is, use the manner of sending alarm information to alert the user of the risk; when the microphone is switched off, the apparatus can also send alarm information, that is, use the manner of stopping sending alarm information to alert the user of the risk. In this embodiment of the present invention, the basis for judging whether alarm information needs to be sent or the manner for alerting the user are not limited, provided that the user can be alerted of the risk.

For the manner of sending alarm information when the microphone is switched on, the alarm apparatus for anti-eavesdropping inside the terminal specifically includes:

a state acquiring unit, adapted to acquire the working state of a microphone of a terminal; and

an alarm information sending unit, adapted to send alarm information according to the working state of the microphone of the terminal.

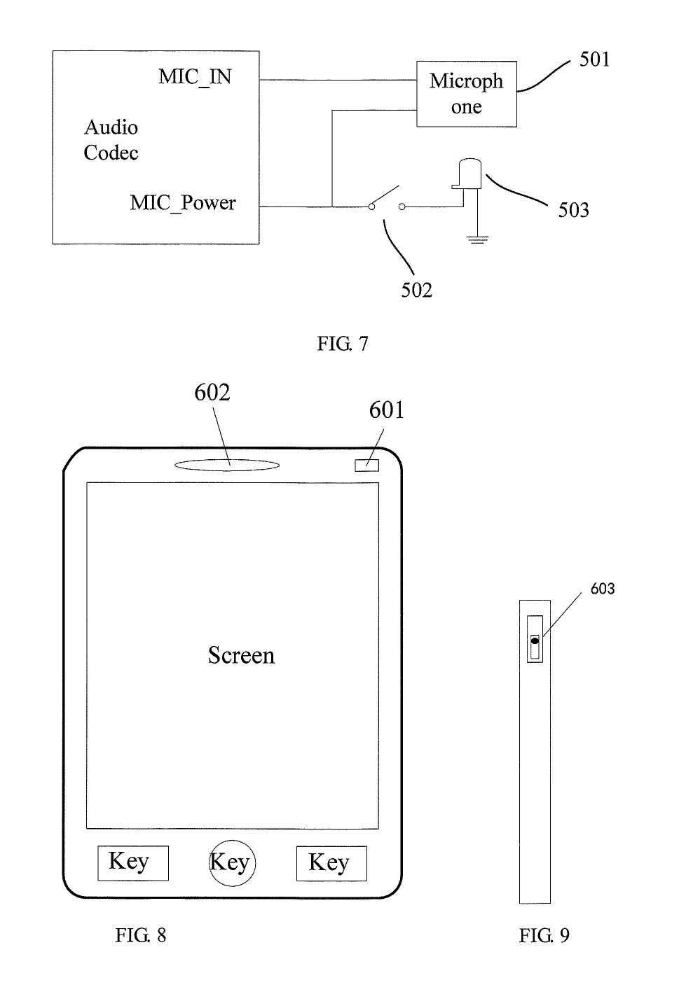

FIG. 7 is a schematic structural diagram of a terminal having an anti-eavesdropping alarm function. The following briefly describes the working process of the terminal.

First, the working state of a microphone 501 is acquired. In the figure, the working state of the microphone is judged based on the power supply state of the microphone. If the power supply of the microphone is turned on (that is, is configured to the Power on state), it indicates that the microphone is working; if the power supply of the microphone is shut down (that is, is configured to the Power off state), it indicates that the microphone is not working, that is, is switched off.

Then, when the microphone 501 is switched on, an enabling switch 502 is closed to turn on an alarm indicator 503 (or another alarm device such as a buzzer), and alarm information is sent to the user.

Finally, after viewing the alarm information, the user checks whether malicious eavesdropping is underway, and can manually switch off the enabling switch 502 so that the alarm indicator 503 stops sending alarm information.

Refer to FIG. 8 and FIG. 9. When the terminal in the embodiment is a mobile phone, alarm information can be sent to the user through an alarm indicator 601 and/or a buzzer 602 arranged on the mobile phone, and the stopping of the sending of alarm information can be controlled through an enabling switch 603 arranged at a side edge of the mobile phone.

It should be noted that the figure only shows the specific locations of the indicator 601 and/or the buzzer 602 and the switch 502, which are not limited thereto. An adjustment can be made as required; for example, the indicator 601 and/or the buzzer 602 and the switch 502 can also be arranged at the back of the terminal or below the screen.

The technical solutions in the present invention can be described in the general context of executable computer instructions executed by a computer, for example, a program unit. Generally, the program unit includes routines, programs, components, data structure, and so on for performing specific tasks or implementing specific abstract data types. The technical solutions in the present invention can also be implemented in distributed computing environments; in these distributed computing environments, tasks are executed by the remote processing devices that are connected through communications networks. In distributed computing environments, the program unit can be arranged within local and remote computer storage media including storage devices.

Each embodiment in the specification is described in a progressive manner. The same or similar parts in the embodiments are just references to each other. Each embodiment emphasizes what is different from the other embodiments. In particular, for the apparatus embodiment, since it is basically similar to the method embodiment, the apparatus embodiment is described simply, and the relevant part may be obtained with reference to the part of the description of the method embodiment. The described apparatus embodiments above are merely exemplary, where the units described as separate parts may be or may not be physically separate, and parts displayed as units may be or may not be physical units, that is, may be located in one position, or may be distributed on multiple network elements. A part of or all of the modules may be selected according to the actual needs to achieve the objectives of the solutions of the embodiments. Persons of ordinary skill in the art may understand and implement the embodiments without creative efforts.

Persons of ordinary skill in the art may appreciate that, in combination with the examples described in the embodiments herein, units and algorithm steps can be implemented by electronic hardware, or a combination of computer software and electronic hardware. Whether the functions are executed by hardware or software depends on the particular applications and design constraint conditions of the technical solutions. Persons skilled in the art can use different methods to implement the described functions for every particular application, but it should not be considered that the implementation goes beyond the scope of the present invention.

It can be clearly understood by persons skilled in the art that, for the purpose of convenient and brief description, for a detailed working process of the foregoing system, apparatus and unit, reference may be made to the corresponding process in the method embodiments, and the details will not be described herein again.

In the embodiments provided in the present application, it should be understood that the disclosed system, apparatus, and method may be implemented in other manners. For example, the described apparatus embodiments are merely exemplary. For example, the unit division is merely logical function division and can be other division in actual implementation. For example, multiple units or components can be combined or integrated into another system, or some features can be ignored or not performed. In addition, the displayed or discussed mutual couplings or direct couplings or communication connections may be implemented through some interfaces. The indirect couplings or communication connections between the apparatuses or units may be implemented in electronic, mechanical or other forms.

The units described as separate parts may be or may not be physically separate, and parts displayed as units may be or may not be physical units, that is, may be located in one position, or may be distributed on multiple network elements. A part or all of the units may be selected according to the actual needs to achieve the objectives of the solutions of the embodiments.

In addition, functional units in the embodiments of the present invention may be integrated into a processing unit, or each of the units may exist separately and physically, or two or more units may be integrated into a unit.

When being implemented in the form of a software functional unit and sold or used as a separate product, the functions may be stored in a computer-readable storage medium. Based on such understanding, the technical solutions of the present invention essentially, or the part contributing to the prior art, or part of the technical solutions may be implemented in a form of a software product. The computer software product is stored in a storage medium, and includes several instructions for instructing a computer device (which may be a personal computer, a server, a network device, and the like) to execute all or part of the steps of the methods described in the embodiments of the present invention. The foregoing storage medium can be any medium that can store program codes, such as a U-disk, a removable hard disk, a read-only memory (ROM, Read-Only Memory), a random access memory (RAM, Random Access Memory), a magnetic disk, or an optical disk.

Based on the embodiments described above, persons skilled in the art can clearly understand that the present invention can be implemented through software and necessary general-purpose hardware. The general-purpose hardware includes general-purpose integrated circuits, general-purpose CPUs, general-purpose storage devices, general-purpose components, and so on. Assuredly, the present invention can also be implemented through special-purpose hardware, including special-purpose integrated circuits, special-purpose CPUs, special-purpose storage devices, special-purpose components, and so on. However, in many circumstances, the former implementation manner is preferred. Based on such understanding, the technical solutions of the present invention essentially, or the part contributing to the prior art may be implemented in a form of a software product. The computer software product is stored in a readable storage medium, for example, a floppy disk, hard disk, or optical disk of the computer, and includes several instructions for instructing a computer device (which may be a personal computer, a server, a network device, and the like) to execute all the methods in the embodiments of the present invention.

The embodiments of the present invention are described in detail above. Although the present invention is described with reference to exemplary embodiments, the description of the embodiments is only intended to help understand the method and device of the present invention. With respect to the specific implementation and application scope, modifications and variations may be made by persons of ordinary skill in the art according to the idea of the present invention. Therefore, the specification shall not be construed as a limitation on the present invention.

What is claimed is:

1. An alarm method for terminal anti-eavesdropping, comprising:
acquiring a working state of a microphone of a terminal; and
sending alarm information according to the working state of the microphone of the terminal.

2. The method according to claim 1, wherein sending the alarm information according to the working state of the microphone of the terminal comprises:
sending the alarm information when the microphone of the terminal is switched on.

3. The method according to claim 1, after sending the alarm information according to the working state of the microphone of the terminal, further comprising:
stopping the alarm information according to a operation of a user.

4. The method according to claim 3, wherein stopping the alarm information according to the operation of the user comprises:
stopping the alarm information according to switch-off or switch-on of a hardware switch by the user.

5. The method according to claim 1, wherein acquiring the working state of the microphone of the terminal comprises:
acquiring a power supply state of the microphone of the terminal, and, when the microphone of the terminal is powered on, determining that the microphone of the terminal is switched on.

6. The method according to claim 1, wherein acquiring the working state of the microphone of the terminal comprises:
acquiring a working state of an audio codec of the terminal, and, when the audio codec is switched on, determining that the microphone of the terminal is switched on.

7. An alarm apparatus for terminal anti-eavesdropping, comprising:
a state acquiring unit, adapted to acquire a working state of a microphone of a terminal; and
an alarm information sending unit, adapted to send alarm information according to the working state of the microphone of the terminal.

8. The apparatus according to claim 7, comprising:
an alarm information sending unit, specifically adapted to send the alarm information when the microphone of the terminal is switched on.

9. The apparatus according to claim 7, further comprising:
a switch unit, adapted to stop the alarm information according to a operation of a user after the alarm information sending unit sends the alarm information.

10. The apparatus according to claim 7, wherein the state acquiring unit comprises:
a power supply state acquiring unit, adapted to acquire a power supply state of the microphone of the terminal; and
a first state judgment unit, adapted to: when the microphone of the terminal is powered on, determine that the microphone of the terminal is switched on.

11. The apparatus according to claim 7, wherein the state acquiring unit comprises:
an audio codec state acquiring unit, adapted to acquire a working state of an audio codec of the terminal; and
a second state judgment unit, adapted to: when the audio codec is switched on, determine that the microphone of the terminal is switched on.

12. A terminal, comprising the alarm apparatus for terminal anti-eavesdropping according to claim 7, wherein the alarm apparatus for anti-eavesdropping is connected to a microphone of the terminal or an audio codec of the terminal; the alarm apparatus for anti-eavesdropping is adapted to acquire a working state of the microphone of the terminal, and send the alarm information according to the working state of the microphone of the terminal.

13. The terminal according to claim 12, wherein the alarm apparatus for anti-eavesdropping comprises:
a state acquiring unit, adapted to acquire the working state of the microphone of the terminal; and
an alarm information sending unit, adapted to send the alarm information according to the working state of the microphone of the terminal.
